(19) United States
(12) Patent Application Publication
(10) Pub. No.: US 2002/0128957 A1
(43) Pub. Date: Sep. 12, 2002

(54) Dispenser inventory monitoring system and method

(75) Inventors: Dean G. Rosenberg, San Diego, CA (US); William K. Holmes, San Diego, CA (US)

Correspondence Address: MICHAEL BEST & FRIEDRICH, LLP, 100 E WISCONSIN AVENUE, MILWAUKEE, WI, 53202, US

(73) Assignee: SupplyPro, Inc., San Diego, CA

(21) Appl. No.: 10/045,482

(22) Filed: Oct. 22, 2001

Related U.S. Application Data
(60) Provisional application No. 60/241,894, filed on Oct. 20, 2000.
(60) Provisional application No. 60/242,417, filed on Oct. 23, 2000.

(51) Int. Cl. G06F 17/60

(52) U.S. Cl. 705/37

(57) ABSTRACT

A method of monitoring inventory within a dispensing cabinet. The method includes using an electronic inventory sensor to determine whether an item is removed, electronically reporting from the inventory sensor to a remote inventory data center that an item is removed, the inventory data center being accessible over a secured internet connection, and sending an electronic order from the inventory data center to a remote vendor to replace the removed item.

### CROSS-REFERENCE TO RELATED APPLICATIONS

This application claims priority under 35 U.S.C. § 119 to provisional patent application serial Nos. 60/241,894 and 60/242,417, filed on Oct. 20, 2000 and Oct. 23, 2000, respectively.

### BACKGROUND AND SUMMARY OF THE INVENTION

The invention relates to a dispensing cabinet. Specifically, the invention relates to the monitoring of an item dispensing cabinet.

Conventional inventory monitoring systems typically include a dispensing cabinet and a plurality of bins within the dispensing cabinet. A sensor is usually employed to monitor when the inventory is removed from the bins of the dispensing system. When an item is removed from the dispensing cabinet, the sensor records the removal and updates the inventory information within a computer associated with the dispensing cabinet. A central data center periodically polls a plurality of dispensing cabinets to compile a central inventory for the entire inventory monitoring system. Periodically, orders are placed based on the inventory information in the data center. A vendor will refill the dispensing cabinets according to the periodic inventory gathered when the data center polls the individual cabinets. The periodic inventory, however, does not reflect the most up-to-date inventory information due to the periodic nature of the report. That is, there is a lag time between when the item is removed and when the periodic report is generated. For example, if one hammer is removed from a dispensing cabinet at 10 a.m., and a second hammer is removed from the dispensing cabinet at 2 p.m., a total of two hammers are removed from the dispensing cabinet on the same day. If the periodic report is generated at 1 p.m., it will only register that one hammer has been removed. A method of monitoring inventory and reporting the most up-to-date inventory information within a dispensing cabinet would be welcomed by users of such systems.

Accordingly, the present invention provides a method of monitoring inventory within a dispensing cabinet. The method includes using an electronic inventory sensor to determine whether an item is removed, electronically reporting from the inventory sensor to a remote inventory data center that an item is removed, the inventory data center being accessible over a secured internet connection, and sending an electronic order from the inventory data center to a remote vendor to replace the removed item.

Other features and advantages of the invention will become apparent to those of ordinary skill in the art upon review of the following detailed description and drawings.

### BRIEF DESCRIPTION OF THE DRAWING

FIG. 1 shows a flow chart illustrating the functionality of a dispenser inventory monitoring system according to the present invention; and

FIG. 2 shows a block diagram of the monitoring system according to the present invention.

### DESCRIPTION OF THE PREFERRED EMBODIMENT

Before one embodiment of the invention is explained in detail, it is to be understood that the invention is not limited in its application to the details of construction and the arrangement of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

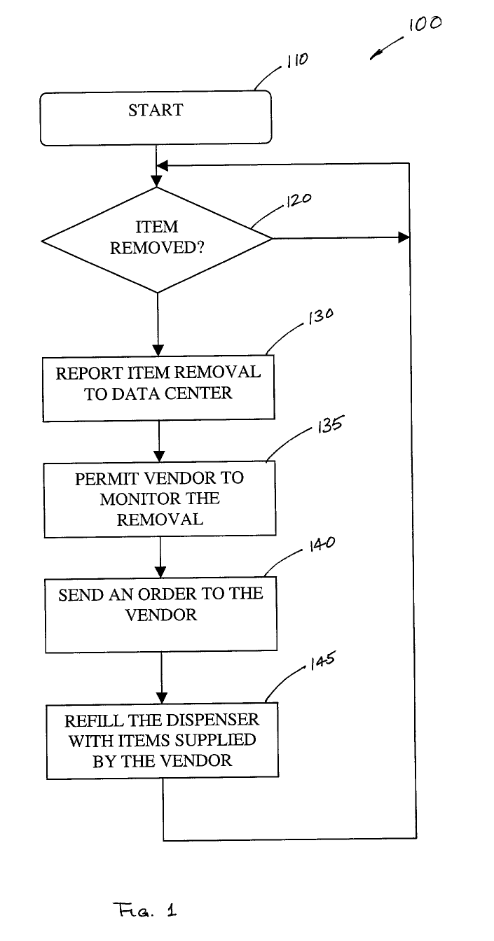

Referring to FIG. 1, a flow chart 100 illustrates a method of monitoring an inventory according to the present invention. The method of monitoring inventory within a dispensing cabinet starts at step 110. Each time an item is removed from the dispensing cabinet (determined in 120), an electronic sensor electronically registers it. When the electronic sensor registers the removal of an item, it electronically reports the information to a remote inventory data center (step 130). The inventory data center is accessible over a secured Internet connection so that inventory information on individual dispensing cabinets can be determined from any terminal connected to the Internet.

Thus the quantity of the removed items can be monitored by a remote vendor over a secured internet connection (step 135). An electronic order is thereafter sent from the inventory data center to a remote vendor to replace the removed item (step 140). The dispensing cabinet is subsequently refilled with items supplied by the remote vendor (step 145).

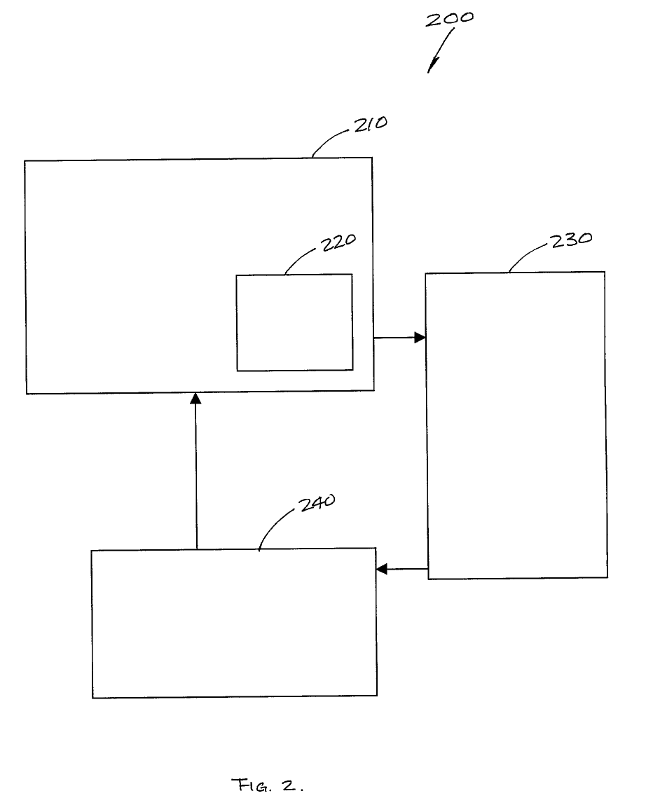

Referring to FIG. 2, a block diagram of the monitoring system 200 according to the present invention is shown. When an item (not shown) is removed from a dispensing cabinet 210, which includes a plurality of compartments (not shown), an electronic inventory sensor 220 associated with the compartment senses the removal and then reports the quantity of items removed to a remote inventory data center 230. The inventory data center 230 in turn permits a remote vendor 240 to monitor the quantity of items removed, and sends a refilling order to the remote vendor 240 to refill the dispensing cabinet with items supplied by the remote vendor.

How items are removed and how much control is exercised may vary based upon the item being removed and the company at which the items are dispensed. Various approaches are described below and can be used in various combinations within a dispensing cabinet.

1. Controlled vs. Non-controlled Access

For certain items, for example office supplies such as pens and pencils, the dispenser does not be need to control access, meaning every user has access to those items and no locking doors or other protection devices are necessary. Further, the company may not even need a user identification before the items are removed. However, tracking inventory is still necessary and items taken and returned still need to be tracked.

For items needing controlled access, in addition to locking doors, other approaches can be utilized. For example, items may be located in a pull out bin of various sizes wherein each bin has thereon or therein a sensor, switch or lock that is releasable to provide approved users access to the items therein.

2. Dispenser Notification of Access

In addition to or in place of controlled access, electronic sensors are employed in various locations throughout the dispensing cabinet to passively indicate that a user has had access to a particular location or bin. Examples of these devices include the following.

a. A wand is mounted across a pocket of the dispenser. As a user reaches for the item desired, the wand is moved indicating access was had by a user.

b. A light beam or curtain, such as an infrared beam, could be employed across a single item dispensing location or across all dispensing locations within the dispenser. The beam is generated such as by an LED and the light received by a sensor. Breaking of the beam or curtain by a user is identified with coordinates, which indicates the user having access to certain items.

c. A bracelet having a smart chip therein could be worn by a user. An RF antenna adjacent each item dispensing location receives a signal from the bracelet to indicate what items where accessed. Alternatively, such a chip could be sewn into a uniform sleeve for the same purpose.

d. An item may be located behind glass. If the glass is broken, the dispenser would be informed. Such an approach is applicable to safety equipment that needs immediate replacement.

e. A magnetic card reader. A credit card type device is hung on a lanyard and the cabinet includes a magnetic card reader or other identification sensing device. The credit card would be placeable into the card reader by the user and held in the card reader while the user accesses the cabinet and removes the desired items. The transactions would then be recorded on the card.

f. A fluid level sensor. If a fluid is to be dispensed or removed from the cabinet, the cabinet can be configured to include a container, such as a drum, having therein a fluid level sensor. As fluid is removed from the cabinet by a user, the level sensor would indicate the amount of fluid removed as well as the amount remaining for restocking purposes.

g. A radio frequency antenna and a radio frequency identity chip on the item. A radio frequency (RF) identity chip or smart chip is attached to the items in the dispensing cabinet, and a radio frequency antenna is installed in the dispensing cabinet. Therefore, the removal of the items from the dispensing cabinet can be recorded by the RF antenna.

h. A scanner. A handheld scanner or any other scanner can be used to scan in the items being removed.

i. A scale. If the items to be removed is measured by weight, nails for example, an appropriate sensor would be a scale, such as an electronic scale. As the items are removed from the dispensing cabinet by a user, the scale sensor would indicate the amount of weight lost as well as the amount remaining for restocking purposes.

j. Pull out bins could be monitored as to how far the bin was pulled outwardly. Depending upon the size of the items in that bin, a distance traveled by the bin could be correlated with an item quantity. The quantity could also be verified by the user.

k. Each item in a location, shelf or bin could be tagged with a smart chip. When the item is removed such as by passing by an RF antenna, the dispenser would know that that item had been removed or, alternately, had been returned. Such smart chips are available from Single Chip Solutions.

3. Tracking Items Taken or Returned

Another general approach to tracking inventory in the dispensing cabinet is to have the user press take and return buttons to indicated quantity. This approach is dependent upon the user remembering to do so. A user interface can prompt the user to press the appropriate buttons or can provide an audio prompt to remind the user to do so. In any event, this approach to tracking inventory is an active approach that requires the user to provide the necessary quantity information. Other active approaches include a keypad, barcode scanner or a voice recognition system so that a user can verbally stated a quantity taken or returned.

1. A method of monitoring inventory within a dispensing cabinet, the method comprising:
electronically sensing with an electronic inventory sensor whether an item is removed from a dispensing cabinet;
electronically reporting from the inventory sensor to a remote inventory data center that an item is removed, the inventory data center being accessible over a secured internet connection;
permitting the quantity of the items within the dispensing cabinet to be monitored by a remote vendor over a computer network;
sending an electronic order from the inventory data center to the remote vendor to refill the removed item; and
refilling the dispensing cabinet with items supplied by the remote vendor.

2. The method of claim 1, wherein the electronic inventory sensor is a wand.

3. The method of claim 1, wherein the electronic inventory sensor is a light beam.

4. The method of claim 1, wherein the electronic inventory sensor is a bracelet having a smart chip.

5. The method of claim 1, further comprising:
breaking glass behind which the item is located.

6. The method of claim 1, wherein the electronic inventory sensor is a fluid level sensor.

7. The method of claim 1, wherein the electronic inventory sensor is a magnetic card reader.

8. The method of claim 1, wherein the electronic inventory sensor comprises a radio-frequency antenna and a radio frequency identity chip on the item.

9. The method of claim 1, wherein the electronic inventory sensor comprises a pull out bin.

10. The method of claim 1, wherein the electronic inventory sensor comprises scanner.

11. The method of claim 1, wherein the electronic inventory sensor comprises a scale.

12. The method of claim 1, wherein the electronic inventory sensor comprises an IR pocket sensor.

13. A dispenser inventory monitor system, the system comprises:
a dispensing cabinet;
a remote inventory data center in electronic communication with the dispensing cabinet;
a remote vendor in electronic communication with the data center; and
a plurality of compartments in the dispensing cabinet, each compartment having an electronic inventory sensor associated with it to electronically monitor an inventory of an item within the compartment and to electronically report the inventory to the remote inventory data center, the data center sending an electronic order to the remote vendor for replacement of the item.

14. The system of claim 13, wherein the electronic inventory sensor is a wand.

15. The system of claim 13, wherein the electronic inventory sensor is a light beam.

16. The system of claim 13, wherein the electronic inventory sensor is a bracelet having a smart chip.

17. The system of claim 13, wherein the item is located behind glass, and the electronic inventory sensor considers the item removed when the glass is broken.

18. The system of claim 13, wherein the electronic inventory sensor is a fluid level sensor.

19. The system of claim 13, wherein the electronic inventory sensor is a magnetic card reader.

20. The system of claim 13, wherein the electronic inventory sensor comprises a radio-frequency antenna and a radio frequency identity chip on the item.

21. The system of claim 13, wherein the electronic inventory sensor comprises a pull out bin.

22. The system of claim 13, wherein the electronic inventory sensor comprises scanner.

23. The system of claim 13, wherein the electronic inventory sensor comprises a scale.

24. The system of claim 13, wherein the electronic inventory sensor comprises an IR pocket sensor.
